(19) United States
(12) Patent Application Publication
(10) Pub. No.: US 2026/0296145 A1
(43) Pub. Date: Oct. 1, 2026

(54) AIR VENT FOR A PASSENGER VEHICLE

(71) Applicant: GM GLOBAL TECHNOLOGY OPERATIONS LLC, Detroit, MI (US)

(72) Inventors: Angel R. MUNOZ, Rochester Hills, MI (US); Steven Jay LEATHORN, Royal Oak, MI (US)

(21) Appl. No.: 19/089,872

(22) Filed: Mar. 25, 2025

(51) Int. Cl. B60H 1/34; B60H 1/00

(52) U.S. Cl. CPC B60H 1/3421; B60H 1/0065; B60H 2001/3471

(57) ABSTRACT

An air vent system includes a housing having a first end, a second end, and an intermediate portion having an inlet. A face plate is mounted to the housing. The face plate includes a first end portion, a second end portion, an upper edge portion and a lower edge portion. A paddle vane system includes a first paddle vane extending along the upper edge portion and a second paddle vane extending along the lower edge portion. A control system is operatively connected to the paddle vane system. The control system is configured to rotate the first paddle vane about a first paddle vane axis and the second paddle vane about a second paddle vane axis to selectively direct air flowing from the inlet between the upper edge and the upper edge portion and the lower edge and the lower edge portion.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to the art of vehicles and, more specifically, to an air vent for a passenger vehicle.

Vehicles include environmental control systems operable to maintain passenger spaces at a comfortable temperature. Passenger compartment surfaces, such as dashboard surfaces, center console surfaces, and the like generally include vents that direct a conditioned airflow into the passenger compartment. The vents are adjustable allowing passengers the ability to direct the airflow into specific areas of the passenger compartment.

In many cases, the vents are bi-directional accommodating upward, downward, and side-to-side adjustments. As a result of the adjustability, the vents are generally large and very noticeable to occupants and take up large areas of space on the dashboard and other passenger compartment surfaces.

### SUMMARY

An air vent system, in accordance with an aspect of the present disclosure, includes a housing having a first end, a second end, and an intermediate portion having an upper edge and a lower edge extending between the first end and the second end. The intermediate portion includes an inlet. A face plate is mounted to the housing. The face plate includes a first end portion, a second end portion, an upper edge portion extending between the first end portion and the second end portion, and a lower edge portion extending between the first end portion and the second end portion. A paddle vane system is pivotally mounted to the face plate. The paddle vane system includes a first paddle vane extending between the first end portion and the second end portion along the upper edge portion and a second paddle vane extending between the first end portion and the second end portion along the lower edge portion. A control system is mounted to the face plate and operatively connected to the paddle vane system. The control system is configured to rotate the first paddle vane about a first paddle vane axis extending between the first end portion and the second end portion and the second paddle vane about a second paddle vane axis extending between the first end portion and the second end portion to selectively direct air flowing from the inlet between the upper edge and the upper edge portion and the lower edge and the lower edge portion.

In other features, the first paddle vane includes a first paddle end, a second paddle end, and a first intermediate paddle portion including a first gear element and the second paddle vane includes a third paddle end, a fourth paddle end, and a second intermediate paddle portion including a second gear element.

In other features, the control system includes a gear rotatably mounted to the face plate, the gear being operatively connected to the first gear element and the second gear element.

In other features, the control system includes a control element operatively connected to the gear, the control element being operable to rotate the gear and pivot the first paddle vane and the second paddle vane about corresponding ones of the first paddle vane axis and the second paddle vane axis.

In other features, the face plate includes an opening that is receptive of the control element.

In other features, a back plate is mounted to the face plate, the gear being rotatably supported between the back plate and the face plate.

In other features, the first gear element comprises a first worm gear and the second gear element comprises a second worm gear.

In other features, the face plate includes a first mounting element at the first end portion and a second mounting element at the second end portion, the face plate being configured to pivot relative to the housing about the first mounting element and the second mounting element.

In other features, the intermediate portion of the housing includes a first curvature defined between the inlet and the upper edge and a second curvature defined between the inlet and the lower edge.

In other features, the first curvature comprises a first concave curvature and the second curvature comprises a second concave curvature.

An airflow control system for an air vent, in accordance with the present disclosure, includes a face plate including a first end portion, a second end portion, an upper edge portion extending between the first end portion and the second end portion, and a lower edge portion extending between the first end portion and the second end portion. A paddle vane system is pivotally mounted to the face plate. The paddle vane system includes a first paddle vane extending between the first end portion and the second end portion along the upper edge portion and a second paddle vane extending between the first end portion and the second end portion along the lower edge portion. A control system is mounted to the face plate and operatively connected to the paddle vane system. The control system is configured to rotate the first paddle vane about a first paddle vane axis extending between the first end portion and the second end portion and the second paddle vane about a second paddle vane axis extending between the first end portion and the second end portion to selectively direct air over the upper edge portion and under the lower edge portion.

In other features, the first paddle vane includes a first paddle end, a second paddle end, and a first intermediate paddle portion including a first gear element and the second paddle vane includes a third paddle end, a fourth paddle end, and a second intermediate paddle portion including a second gear element.

In other features, the control system includes a gear rotatably mounted to the face plate, the gear being operatively connected to the first gear element and the second gear element.

In other features, the control system includes a control element operatively connected to the gear, the control element being operable to rotate the gear and pivot the first paddle vane and the second paddle vane about corresponding ones of the first paddle vane axis and the second paddle vane axis.

In other features, the face plate includes an opening that is receptive of the control element.

In other features, a back plate is mounted to the face plate, the gear being rotatably supported between the back plate and the face plate.

In other features, the first gear element comprises a first worm gear and the second gear element comprises a second worm gear.

In other features, a housing supports the face plate, the housing includes a first end, a second end, and an intermediate portion having an upper edge and a lower edge extending between the first end and the second end. The intermediate portion includes an inlet.

In other features, the face plate includes a first mounting element at the first end portion and a second mounting element at the second end portion, the first mounting element being connected to the first end of the housing and the second mounting element being connected to the second end of the housing, the face plate being configured to pivot relative to the housing about the first mounting element and the second mounting element.

A vehicle, in accordance with the present disclosure, includes a body, a plurality of wheels supporting the body, a passenger compartment defined within the body, and an air vent system provided in the passenger compartment. The air vent system includes a housing having a first end, a second end, and an intermediate portion having an upper edge and a lower edge extending between the first end and the second end. The intermediate portion includes an inlet. A face plate is mounted to the housing. The face plate includes a first end portion, a second end portion, an upper edge portion extending between the first end portion and the second end portion, and a lower edge portion extending between the first end portion and the second end portion. A paddle vane system is pivotally mounted to the face plate. The paddle vane system includes a first paddle vane extending between the first end portion and the second end portion along the upper edge portion and a second paddle vane extending between the first end portion and the second end portion along the lower edge portion. A control system is mounted to the face plate and operatively connected to the paddle vane system. The control system is configured to rotate the first paddle vane about a first paddle vane axis extending between the first end portion and the second end portion and the second paddle vane about a second paddle vane axis extending between the first end portion and the second end portion to selectively direct air flowing from the inlet between the upper edge and the upper edge portion and the lower edge and the lower edge portion.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a left side partial perspective view of a vehicle including a passenger compartment having an air vent system, in accordance with the present disclosure;

FIG. 2 is a perspective view of an air vent including a base plate and a face plate for the vehicle, in accordance with the present disclosure;

FIG. 3 is a partially disassembled view of the air vent or FIG. 2, in accordance with the present disclosure;

FIG. 4 is a cross-sectional perspective view of the air vent of FIG. 2, in accordance with the present disclosure;

FIG. 5 is a disassembled view of the face plate and paddle vanes of the air vent or FIG. 2, in accordance with the present disclosure;

FIG. 6 is cross-sectional side view of the air vent, in accordance with the present disclosure;

FIG. 7 is a glass view of the face plate of the air vent, in accordance with the present disclosure; and

FIG. 8 is a perspective view of the paddle vanes and control knob of the air vent, in accordance with the present disclosure;

FIG. 9A is a cross-sectional side view of the paddle vanes of the air vent of FIG. 2 in a first orientation, in accordance with the present disclosure;

FIG. 9B is a cross-sectional side view of the paddle vanes of the air vent of FIG. 2 in a second orientation, in accordance with the present disclosure;

FIG. 9C is a cross-sectional side view of the paddle vanes of the air vent of FIG. 2 in a third orientation, in accordance with the present disclosure;

FIG. 10A is a cross-sectional side view of the face plate of the air vent of FIG. 2 in a first orientation, in accordance with the present disclosure;

FIG. 10B is a cross-sectional side view of the face plate of the air vent of FIG. 2 in a second orientation, in accordance with the present disclosure; and

FIG. 10C is a cross-sectional side view of the face plate of the air vent of FIG. 2 in a third orientation, in accordance with the present disclosure.

In the drawings, reference numbers may be reused to identify similar and/or identical elements.

### DETAILED DESCRIPTION

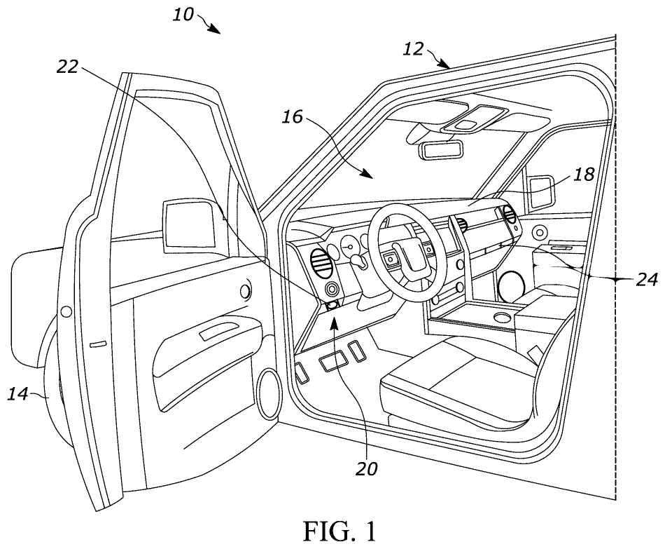

Referring to FIG. 1, a vehicle 10 includes a body 12 supported on a plurality of wheels 14. Vehicle 10 includes a passenger compartment 16 within which is mounted a dashboard 18. Vehicle 10 includes an environmental control system (not shown) that is selectively operated to condition passenger compartment 16. The refrigeration system directs an airflow into the passenger compartment that establishes a selected environment for passengers. The airflow passes into passenger compartment 16 via an air vent system 20 including a first air vent 22 and a second air vent 24 mounted to dashboard 18. Additional air vents may be located in other areas of vehicle 10 including seat surfaces, console surfaces, floor surfaces and the like.

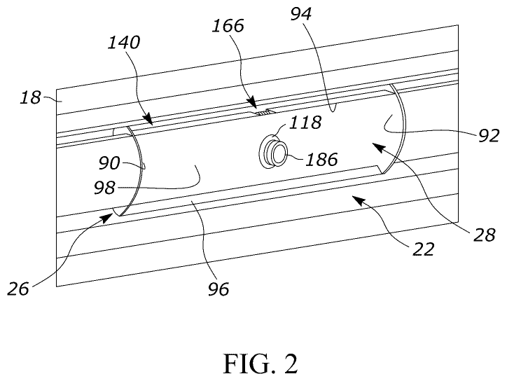

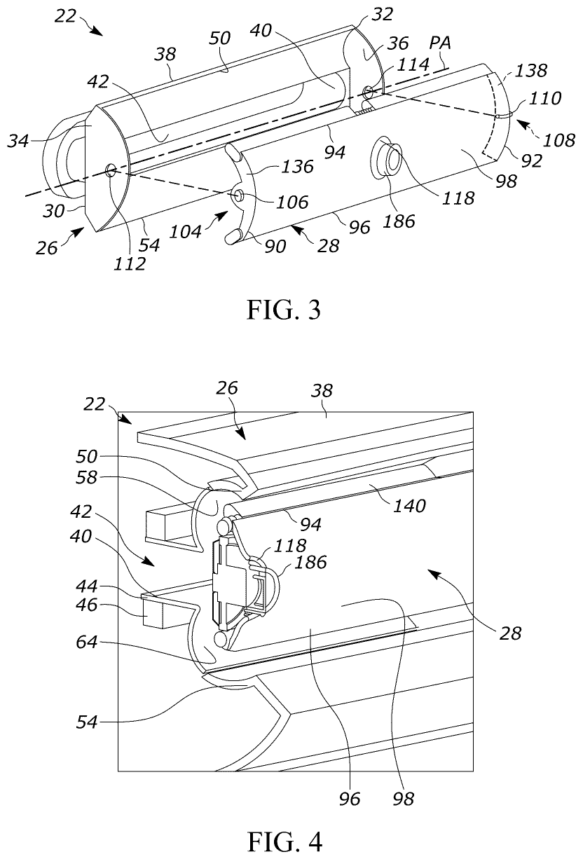

Reference will now follow to FIGS. 2, 3, and 4 in describing first air vent 22 with an understanding that second air vent 24 includes similar structure. First air vent 22 includes a housing 26 that may be integrated into dashboard 18 and a face plate 28. As will be detailed more fully herein, face plate 28 allows a passenger to control a direction and forces of the airflow passing from the environmental control system. As shown in FIG. 3, housing 26 includes a first end 30 and a second end 32. A first face plate support 34 is provided at first end 30 and a second face plate support 36 is provided at second end 32.

Housing 26 also includes an intermediate portion 38 that extends between first end 30 and second end 32. Intermediate portion 38 includes an opening 40 that defines an inlet 42. Opening 40 is shown in the form of an elongated slot (not separately labeled) having curvilinear ends (also not separately labeled). It should, however, be understood that the geometry of opening 40 may vary. Inlet 42 includes an inner end 44 provided with a seal 46 that may engage with a duct (not shown) connected to the environmental control system.

Housing 26 is further shown to include an upper edge 50 and a lower edge 54 that extend between first end 30 and second end 32. Intermediate portion 38 includes a first guide surface 58 having a first curvature and a second guide surface 64 having a second curvature. First guide surface 58 extends from inlet 42 to upper edge 49 and second guide surface 64 extends from inlet 42 to lower edge 54.

In accordance with an aspect of the present disclosure, the first curvature is a first concave curvature, and the second curvature is a second concave curvature. First guide surface 58 and second guide surface 64 shape the airflow passing from air vent system 20. While the first curvature and the second curvature appear to be similar, it should be understood that different geometries may be employed to shape the airflow for a particular passenger compartment.

In accordance with the present disclosure, the first and second curvatures contribute to shaping the airflow passing through first air vent 22. More specifically, air vent system 20 relies on the Coanda effect which is the tendency of a fluid to stay attached to a surface of any form. In accordance with the present disclosure, air passing though inlet 42 will flow along first guide surface 58 toward upper edge 49 and along second guide surface 64 towards lower edge 54.

With continued reference to FIG. 3, face plate 28 includes a first end portion 90 and a second end portion 92. Face plate 28 is also shown to include an upper edge portion 94 and a lower edge portion 96. Upper edge portion 94 and lower edge portion 96 extend between first end portion 90 and second end portion 92.

Face plate 28 includes an outer, curvilinear surface 98. Face plate 28 is also shown to include a first mounting element 104 having a first pin 106 arranged at first end portion 90 and a second mounting element 108 having a second pin 110 arranged at second end portion 92. First pin 106 extends through a first support opening 112 formed in first face plate support 34 and second pin 110 extends through a second support opening 114 formed in second face plate support 36. With this construction, face plate 28 may pivot about a central pivot axis “PA” relative to housing 26. Pivot axis PA extends between first end portion 90 and second end portion 92. More specifically, pivot axis PA extends between first support opening 112 and second support opening 114.

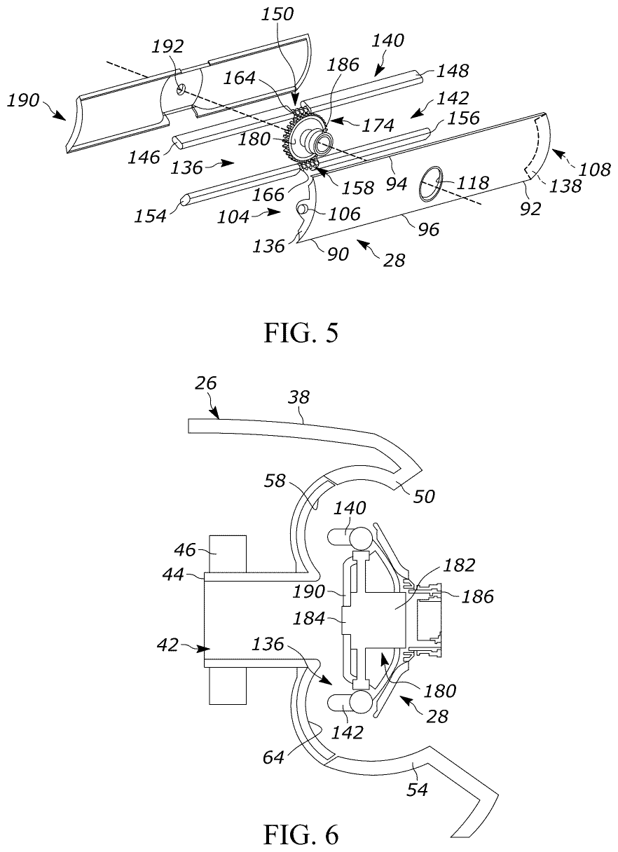

In accordance with the present disclosure, face plate 28 includes an opening 118 (FIG. 5) formed in curvilinear surface 98. Face plate 28 supports a paddle vane system 134 that is pivoted to control a direction of air flow passing from first air vent 22 as will be detailed more fully herein. Paddle vane system 134 is pivotally mounted between a first support member 136 provided at first end portion 90 of face plate 28 and a second support member 138 provided at second end portion 92 of face plate 28. First support member 136 also supports first mounting element 104 and second support member 138 also supports second mounting element 108.

Referring to FIGS. 4, 5, and 6 and with continued reference to FIG. 3, paddle vane system 134 includes a first paddle vane 140 and a second paddle vane 142. First paddle vane 140 is pivotally supported between first support member 136 and second support member 138 and extends along upper edge portion 94 and second paddle vane 142 is pivotally supported between first support member 136 and second support member 138 along lower edge portion 96.

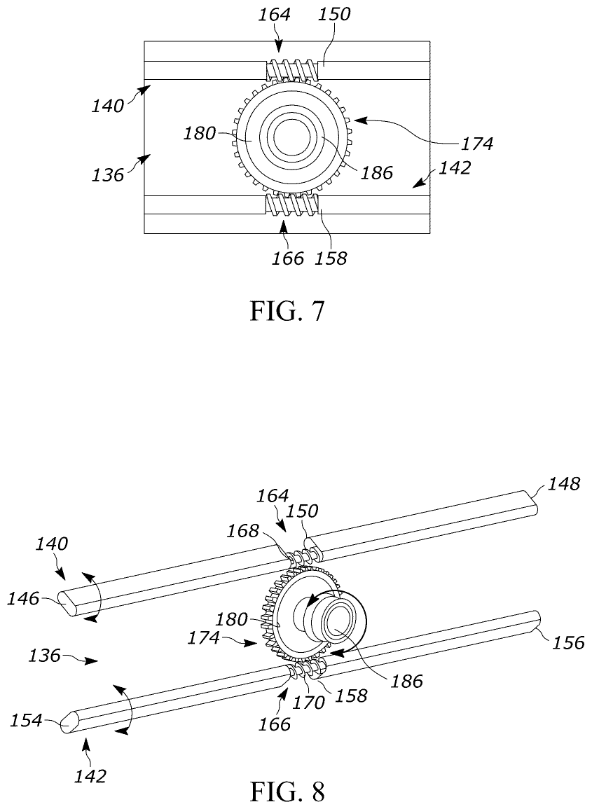

More specifically, first paddle vane 140 includes a first paddle end 146 connected to first support member 136, a second paddle end 148 connected to second support member 138 and a first intermediate paddle portion 150. Similarly, second paddle vane 142 includes a third paddle end 154 connected to first support member 136, a fourth paddle end 156 connected to second support member 138 and a second intermediate paddle portion 158. As shown in FIGS. 7 and 8 and with continued reference to FIG. 5, first paddle vane 140 includes a first gear element 164 arranged centrally along first intermediate paddle portion 150 and second paddle vane 142 includes a second gear element 166 arranged centrally along second intermediate paddle portion 158. First gear element 164 comprises a first worm gear 168 and second gear element 166 comprises a second worm gear 170.

In accordance with the present disclosure, paddle vane system 134 is connected to a paddle control system 174. As shown in FIGS. 6, 7, and 8, paddle control system 174 includes a gear 180 operatively connected to first worm gear 168 and second worm gear 170. Gear 180 includes a first axle 182 and a second axle 184. First axle 182 is connected to a control knob 186 that extends through opening 118 in face plate 28. Second axle 184 is supported by a back plate 190 (FIG. 5) connected to face plate 28. More specifically, back plate 190 includes an axle support 192 that is receptive of second axle 184. With this construction, gear 180 is rotatable supported between face plate 28 and back plate 190 and may be actuated by turning control knob 186.

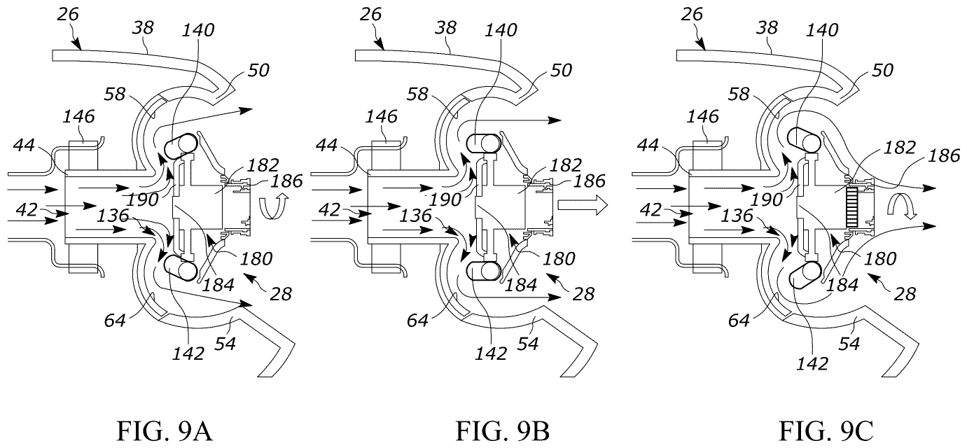

In accordance with the present disclosure, rotating control knob 186 in a first direction, for example, counter-clockwise, causes gear 180 to interact with first worm gear 168 and second worm gear 170 rotating first paddle vane 140 and second paddle vane 142 inwardly about corresponding ones of the first paddle axis and the second paddle axis as shown in FIG. 9A. The inward rotation of first paddle vane 140 and second paddle vane 142 results in a diffusion of air passing from air vent system 20. That is, air passing from inlet 42 follows the contours of first guide surface 58 and second guide surface 64 to pass between upper edge 49 and upper edge portion 94 and between lower edge 54 and lower edge portion 96 creating a wide airstream.

Rotating the control knob 186 in a second direction, for example, clockwise, causes first paddle vane 140 and second paddle vane 142 to be substantially perpendicular to the air flow, as shown in FIG. 9B. In this orientation, the airflow passing from air vent system 20 is substantially straight. Finally, further rotation of control knob 186 clockwise, causes first paddle vane 140 and second paddle vane 142 to rotate outwardly, as shown in FIG. 9C, causing the airflow passing from first air vent 22 to be more concentrated.

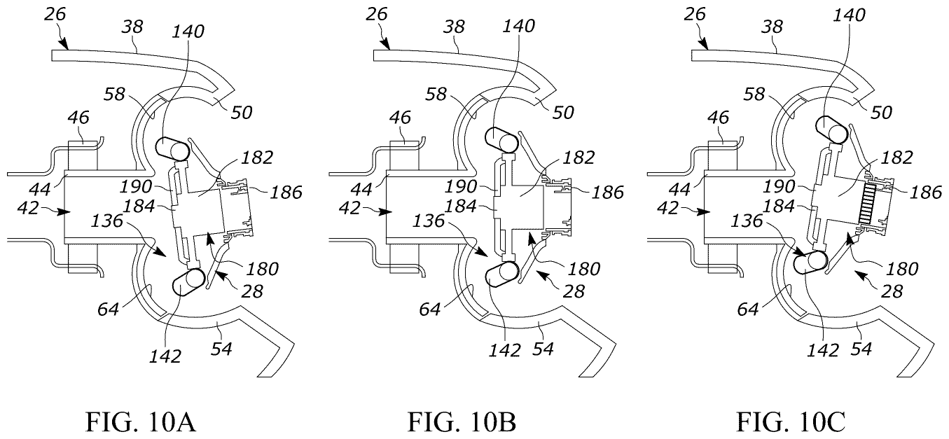

In addition to controlling the nature of the air flow, e.g., between diffused and concentrated airflows, face plate 28 may be rotated upwardly as shown in FIG. 10A, positioned centrally as shown in FIG. 10B, and/or rotated downwardly as shown in FIG. 10C to control a height of the air flow. At this point, it should be appreciated that the air vent system 20 in accordance with the present disclosure provides for selectively controllable air discharge without the need for vents having a large and very perceivable footprint.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

The terms “a” and “an” do not denote a limitation of quantity, but rather denote the presence of at least one of the referenced item. The term “or” means “and/or” unless clearly indicated otherwise by context. Reference throughout the specification to “an aspect,” means that a particular element (e.g., feature, structure, step, or characteristic) described in connection with the aspect is included in at least one aspect described herein and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is

1. An air vent system comprising:
a housing including a first end, a second end, and an intermediate portion having an upper edge and a lower edge extending between the first end and the second end, the intermediate portion including an inlet;
a face plate mounted to the housing, the face plate including a first end portion, a second end portion, an upper edge portion extending between the first end portion and the second end portion, and a lower edge portion extending between the first end portion and the second end portion;
a paddle vane system pivotally mounted to the face plate, the paddle vane system including a first paddle vane extending between the first end portion and the second end portion along the upper edge portion and a second paddle vane extending between the first end portion and the second end portion along the lower edge portion; and
a control system mounted to the face plate and operatively connected to the paddle vane system, the control system being configured to rotate the first paddle vane about a first paddle vane axis extending between the first end portion and the second end portion and the second paddle vane about a second paddle vane axis extending between the first end portion and the second end portion to selectively direct air flowing from the inlet between the upper edge and the upper edge portion and the lower edge and the lower edge portion.

2. The air vent system according to claim 1, wherein the first paddle vane includes a first paddle end, a second paddle end, and a first intermediate paddle portion including a first gear element and the second paddle vane includes a third paddle end, a fourth paddle end, and a second intermediate paddle portion including a second gear element.

3. The air vent system according to claim 2, wherein the control system includes a gear rotatably mounted to the face plate, the gear being operatively connected to the first gear element and the second gear element.

4. The air vent system according to claim 3, wherein the control system includes a control element operatively connected to the gear, the control element being operable to rotate the gear and pivot the first paddle vane and the second paddle vane about corresponding ones of the first paddle vane axis and the second paddle vane axis.

5. The air vent system according to claim 4, wherein the face plate includes an opening that is receptive of the control element.

6. The air vent system according to claim 4, further comprising: a back plate mounted to the face plate, the gear being rotatably supported between the back plate and the face plate.

7. The air vent system according to claim 2, wherein the first gear element comprises a first worm gear and the second gear element comprises a second worm gear.

8. The air vent system according to claim 1, wherein the face plate includes a first mounting element at the first end portion and a second mounting element at the second end portion, the face plate being configured to pivot relative to the housing about the first mounting element and the second mounting element.

9. The air vent system according to claim 1, wherein the intermediate portion of the housing includes a first curvature defined between the inlet and the upper edge and a second curvature defined between the inlet and the lower edge.

10. The air vent system according to claim 9, wherein the first curvature comprises a first concave curvature and the second curvature comprises a second concave curvature.

11. An airflow control system for an air vent comprising:
a face plate including a first end portion, a second end portion, an upper edge portion extending between the first end portion and the second end portion, and a lower edge portion extending between the first end portion and the second end portion;
a paddle vane system pivotally mounted to the face plate, the paddle vane system including a first paddle vane extending between the first end portion and the second end portion along the upper edge portion and a second paddle vane extending between the first end portion and the second end portion along the lower edge portion; and
a control system mounted to the face plate and operatively connected to the paddle vane system, the control system being configured to rotate the first paddle vane about a first paddle vane axis extending between the first end portion and the second end portion and the second paddle vane about a second paddle vane axis extending between the first end portion and the second end portion to selectively direct air over the upper edge portion and under the lower edge portion.

12. The airflow control system according to claim 11, wherein the first paddle vane includes a first paddle end, a second paddle end, and a first intermediate paddle portion including a first gear element and the second paddle vane includes a third paddle end, a fourth paddle end, and a second intermediate paddle portion including a second gear element.

13. The airflow control system according to claim 12, wherein the control system includes a gear rotatably mounted to the face plate, the gear being operatively connected to the first gear element and the second gear element.

14. The airflow control system according to claim 13, wherein the control system includes a control element operatively connected to the gear, the control element being operable to rotate the gear and pivot the first paddle vane and the second paddle vane about corresponding ones of the first paddle vane axis and the second paddle vane axis.

15. The airflow control system according to claim 14, wherein the face plate includes an opening that is receptive of the control element.

16. The airflow control system according to claim 14, further comprising: a back plate mounted to the face plate, the gear being rotatably supported between the back plate and the face plate.

17. The airflow control system according to claim 12, wherein the first gear element comprises a first worm gear and the second gear element comprises a second worm gear.

18. The airflow control system according to claim 11, further comprising: a housing supports the face plate, the housing including a first end, a second end, and an intermediate portion having an upper edge, a lower edge extending between the first end and the second end, the intermediate portion including an inlet.

19. The airflow control system according to claim 18, wherein the face plate includes a first mounting element at the first end portion and a second mounting element at the second end portion, the first mounting element being connected to the first end of the housing and the second mounting element being connected to the second end of the housing, the face plate being configured to pivot relative to the housing about the first mounting element and the second mounting element.

20. A vehicle comprising:
a body;
a plurality of wheels supporting the body;
a passenger compartment defined within the body, and
an air vent system provided in the passenger compartment, the air vent system comprising:
a housing including a first end, a second end, and an intermediate portion having an upper edge and a lower edge extending between the first end and the second end, the intermediate portion including an inlet;
a face plate mounted to the housing, the face plate including a first end portion, a second end portion, an upper edge portion extending between the first end portion and the second end portion, and a lower edge portion extending between the first end portion and the second end portion;
a paddle vane system pivotally mounted to the face plate, the paddle vane system including a first paddle vane extending between the first end portion and the second end portion along the upper edge portion and a second paddle vane extending between the first end portion and the second end portion along the lower edge portion; and
a control system mounted to the face plate and operatively connected to the paddle vane system, the control system being configured to rotate the first paddle vane about a first paddle vane axis extending between the first end portion and the second end portion and the second paddle vane about a second paddle vane axis extending between the first end portion and the second end portion to selectively direct air flowing from the inlet between the upper edge and the upper edge portion and the lower edge and the lower edge portion.
